(19) United States
(12) Patent Application Publication
(10) Pub. No.: US 2023/0079948 A1
(43) Pub. Date: Mar. 16, 2023

(54) Toothbrush

(71) Applicant: CONNECT4ENGINEERING LIMITED, Leicester (GB)

(72) Inventor: Bobby Singh, Leicester (GB)

(21) Appl. No.: 17/917,289

(22) PCT Filed: May 20, 2020
(86) PCT No.: PCT/GB2020/051233

§ 371 Date: Oct. 6, 2022

(51) Int. Cl. A46B 15/00; A46B 5/00; A46D 1/00; A46B 5/02; G10D 7/03; G10D 9/10; G10D 9/08; G10D 7/026

(52) U.S. Cl. CPC A46B 15/0055; A46B 5/0095; A46B 15/0087; A46D 1/0215; A46D 1/0207; A46B 5/02; G10D 7/03; G10D 9/10; G10D 9/08; G10D 7/026; A46B 2200/01; A46B 2200/1066

(57) ABSTRACT

The present invention relates to a toothbrush comprising a head portion comprising a cleaning formation for cleaning teeth in use. A handle portion is connected to the head portion. The toothbrush comprises a musical wind instrument, the wind instrument comprising a resonant cavity extending within one or both of the head portion and the handle portion, and an air inlet operatively connected to the cavity and configured to induce resonance with the cavity by exhalation from the user in use.

### INTRODUCTION

U.S. Pat. No. 6,260,227B1 discloses a prior art toothbrush arrangement. The toothbrush comprises a head portion 30 comprising a plurality of bristles 41 (see FIG. 8). The head portion 30 is removably connected to a handle portion 1 to allow replacement of the head 30, for example, to allow attachment of a head 30 comprising bristles of a different type.

The inventor has found numerous drawbacks with prior art toothbrushes. The removable head portion 30 of U.S. Pat. No. 6,260,227B1 may allow the user to replace the head 30 when the bristles 41 are depleted. This reduces the need to replace the handle 1, thus reducing waste. However, the head portion 30/bristles 41 are made from synthetic material (i.e. plastic), which may be difficult or impossible to recycle. Thus, the toothbrush still produces undesirable waste.

Additionally, it can be difficult to encourage children to regularly brush their teeth. Some prior art toothbrushes incorporate child friendly artwork or sculptures, however, such additions may have limited appeal for some children. Furthermore, the sculptures typically comprise plastic mouldings, which increase the environmental impact of the toothbrush.

It is an aim of the present invention to overcome or ameliorate one or more of the above problems.

### STATEMENT OF INVENTION

According to a first aspect of the invention, there is provided: a toothbrush comprising: a head portion comprising a cleaning formation for cleaning teeth in use; a handle portion connected to the head portion; where the toothbrush comprises a musical wind instrument, the wind instrument comprising a resonant cavity extending within one or both of the head portion and the handle portion, and an air inlet operatively connected to the cavity and configured to induce resonance with the cavity by exhalation from the user in use.

Optional features of the invention are defined by the dependent claims.

According to a further aspect of the invention, there is provided a toothbrush comprising: a head portion comprising a cleaning formation for cleaning teeth in use; a handle portion connected to the head portion; where the toothbrush comprises a musical wind instrument, the wind instrument comprising a resonant cavity extending within one or both of the head portion and the handle portion, an air inlet operatively connected to the cavity and configured to induce resonance with the cavity by exhalation from the user in use, and an air outlet/splitter opening spaced from the inlet the air outlet/splitter permitting air to pass between the cavity and the ambient environment to produce a musical tone.

### DETAILED DESCRIPTION

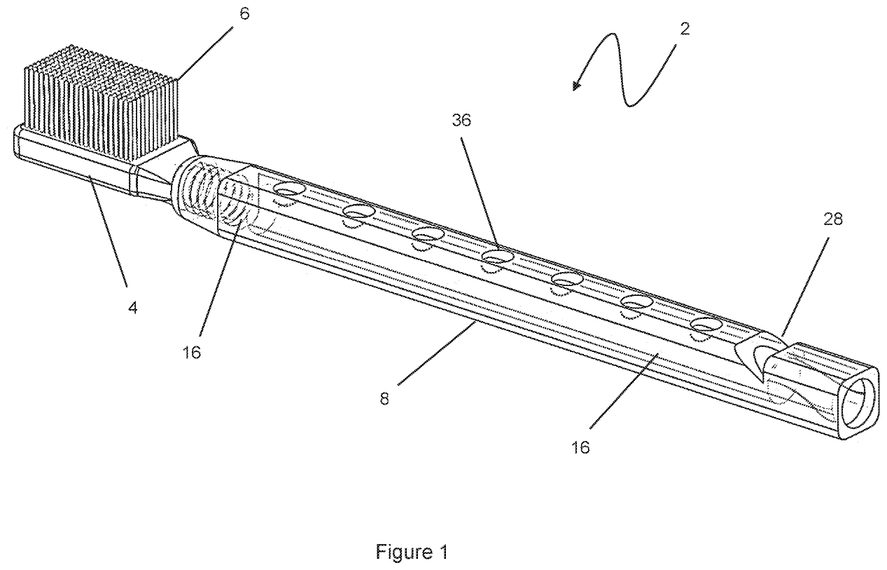

FIG. 1 shows a three-dimensional view of a toothbrush;

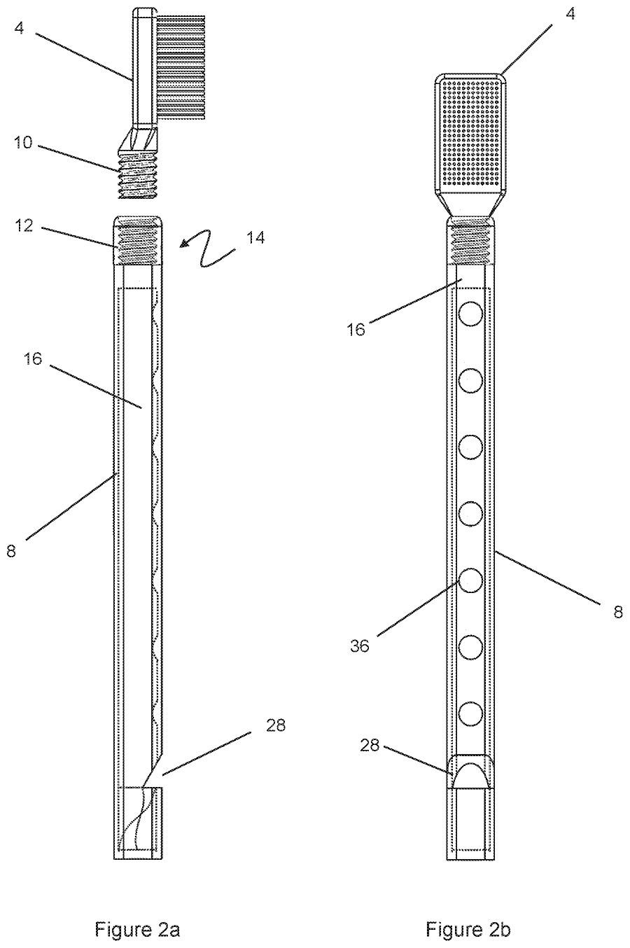

FIG. 2a shows a side view of the toothbrush in a partially dissembled state;

FIG. 2b shows a top view of the toothbrush;

FIG. 3 shows a three-dimensional view of a handle portion of the toothbrush;

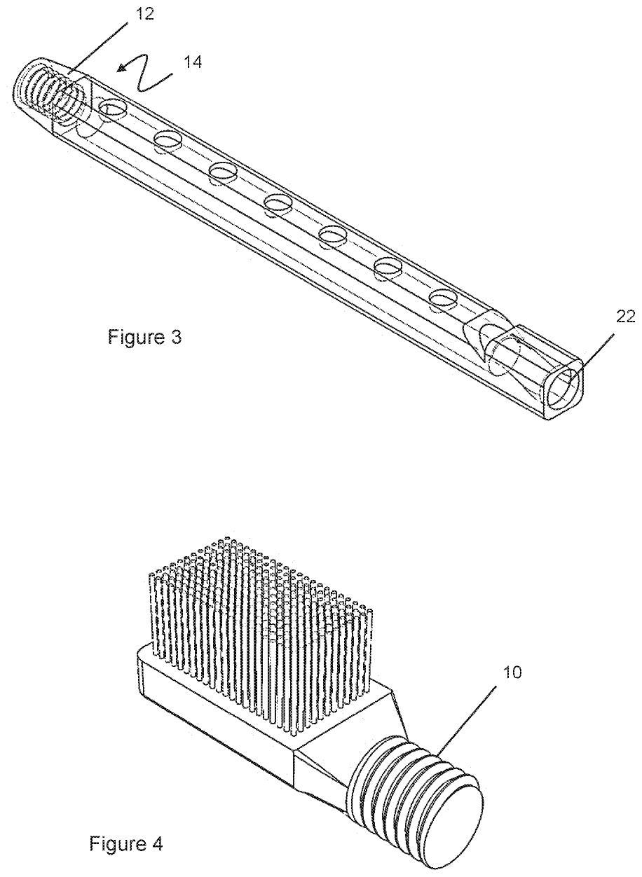

FIG. 4 shows a three-dimensional view of a head portion of the toothbrush;

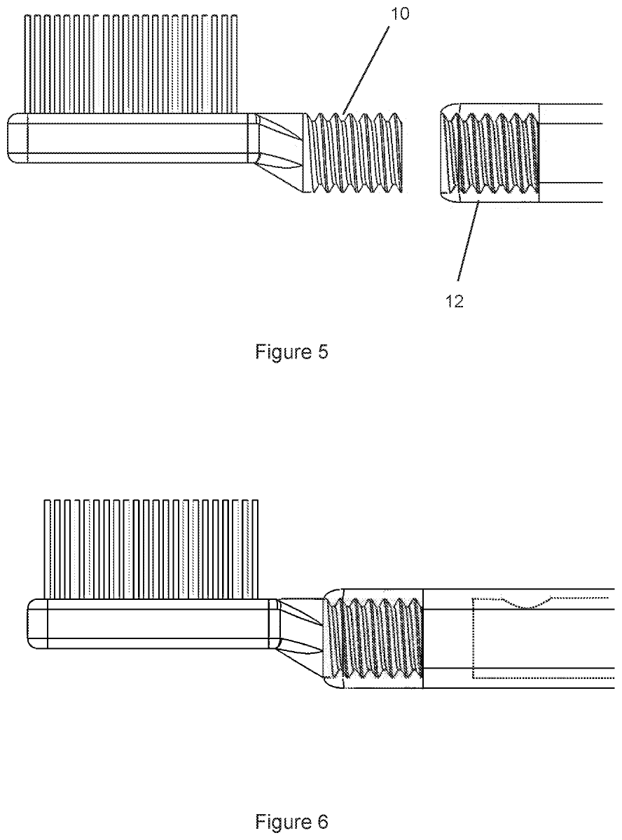

FIG. 5 shows a close-up side view of the toothbrush in a partially dissembled state;

FIG. 6 shows a close-up side view of the toothbrush in an dissembled state;

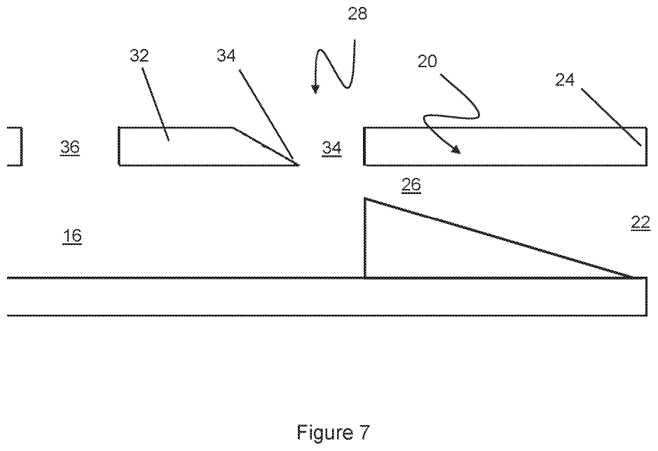

FIG. 7 shows a schematic cross-sectional side view of an air inlet of the toothbrush;

FIG. 1 shows a toothbrush 2. The toothbrush 2 comprises a head portion 4. The head 4 comprises a plurality of bristles 6 configured to clean the user teeth in use. The bristles 6 are upstanding from the head 4. The bristles 6 are typically conventional in shape or form.

The toothbrush 2 comprises a handle potion 8. The handle 8 allows the user to grip the toothbrush 2 in use. The handle 8 typically comprises an elongate member.

The head 4 is removably attached to the handle 8. This allows replacement of the head 4, for example, is the bristles 6 are depleted. Additionally or alternatively, this provides a compact configuration, for example, if the user is travelling.

In the present embodiment, the head 4 is connected to the handle via a screw connection. As best seen in FIGS. 3-6, the head 4 comprises a screw thread 10. A corresponding screw thread 12 is provided on the handle 8. The screw thread 12 is provided at an end 14 of the handle 2. A stop member may be provided (e.g.

a protrusion, rib or plate etc.) to ensure correct orientation of the head 4 when it is screwed fully in place.

In the present embodiment, the head 4 comprises a male screw thread, and the handle 8 comprises a female screw thread. However, it can be appreciated, that the male screw thread may be provided on the handle 8 and the female screw thread on the head 4.

In other embodiments, the head 4 is connected to the handle 8 via an alternative connection means, for example, snap fit, press fit, interference fit, a latch, a fasteners/pin, or other conventional means.

The use of a screw thread provides a simple connection means for children to operate. Additionally or alternatively, this accommodates higher design tolerances than, for example, an interference fit.

A plurality of heads 4 comprising different size heads 4/bristles 6 may be provided. For example, a large size for adults and a small size for children. The same handle 8 may therefore be used for multiple people. This may encourage children to use the brush in a “learn by example” fashion. Additionally or alternatively, the different heads may comprise a different softness of bristles (e.g. hard, sensitive soft etc.)

In addition to its conventional function, the toothbrush is configured to provide a musical instrument. This encourages children to be more actively engaged with the tooth brushing purpose, thus encouraging them to improve/maintain their oral hygiene. Additionally, this encourages the child to learn to play a musical instrument, which may lead to other social or academic improvements. The combination of the musical instrument and the toothbrush thus leads to improvement in multiple aspects of the child's development. Furthermore, this provides a multi-functional device, thus reducing the cost of providing the separate toothbrush and musical instrument, which may be pertinent in developing countries.

In the present embodiment, the toothbrush 2 is configured to provide a wind instrument. The user therefore blows into/across the toothbrush 2 to generate a sound.

The handle 8 comprises a cavity 16 therein. The cavity 16 provides a resonance chamber. Movement of air within the resonance chamber generates a standing wave, which produces a musical note. The cavity 16 may extend substantially the full length of the handle 8. The handle 8 may therefore be tubular. The cavity 16 may comprises a closed end 18 adjacent the end 14 of the handle adjacent the head 4.

As shown most clearly in FIG. 7, an air inlet 20 is provided on an opposing end 18 of the handle 8 to the head 4. The inlet 20 comprises an aperture 22 provide on the end face 24 of the handle 2. The inlet 20 may comprise a constriction 26 (i.e. a tapered or narrowed area) therein. Such constrictions are commonly referred to as a “fipple”. The constriction 26 channels the air into a jet. The constriction 26 is shown in FIG. 7 is merely schematic, and it can be appreciated the construction 26 may take any suitable form. For example, the constriction 26 may be provided by a fipple plug or block.

The air inlet 20 may comprise a mouthpiece of the like. For example, end 14 of the handle 8 may be tapered, or arcuate to rest on the user's lower lip.

Adjacent the constriction 26 (i.e. downstream thereof), an air splitter 28 is provided. The air splitter 28 splits the air into two separate streams, thus “pinning” the beginning airwave at the air splitter 28. The air splitter may be commonly referred to as a “labium”. The air splitter 28 comprises an aperture 30 provide in a side wall 32 of the handle 8. The aperture 30 is tapered, thus providing a sharp edge 34 (or labium lip) facing the inlet 20. The sharp edge 34 therefore divides the air jet. As best seen in FIG. 1 or 2a, the air splitter 28 comprises a triangular or wedge-shaped notch in the side wall 32 of the handle 8.

Such an arrangement is referred to as a “closed flute”. The toothbrush 2 therefore may provide a recorder, ocarina, whistle or organ pipe etc.

In other embodiments, an “open flute” arrangement may be used. In such an arrangement, the constriction is not required, and the user may blow directly onto the air splitter. For example, the user may blow across the end face 24 of the handle. The toothbrush therefore may provide a transverse flute, panpipe or shakuhachi etc.

In further embodiments, the toothbrush may provide a “reed” instrument. In such an embodiment, the air splitter 28 is replaced by a flexible cantilever (e.g. a reed), which agitates the air within the cavity 16 to produce a note.

The “open flute”, “closed flute” and “reed” instruments may be referred to as woodwind instruments.

Referring back to FIG. 1, a plurality of apertures 36 are provided on the handle 8. The apertures 36 open into the cavity 16, thereby allowing variation of the pitch of the note generated by the instrument by selective obscuring thereof. The apertures 36 provide finger holes. The apertures 36 are spaced along the length of the handle 8/cavity 16.

Seven apertures 36 are provided in the present embodiment. The apertures 36 are all provide on a single side of the handle 8. However, it can be appreciated that one or more apertures 36 can be provided on an opposing side and/or other sides of the handle 8 (e.g. to provide a thumb hole).

The exact size/spacing/orientation of the apertures 36 will be determined according to the desired musical parameters of the musical instrument, as will be understood by the skilled person. Similarly, other functional features of the musical instrument, such as the constriction 26, air splitter 28 and air inlet 20 will be configured accordingly. It can be appreciated therefore that the exact configuration of musical instrument depicted in the figures is merely exemplary, and any suitable functional configuration may be provided.

In some embodiments, valves and/or sliders may be used to vary the pitch of the note produced.

In some embodiments, the cavity 16 may at least partially extend into the head 4. The cavity 16 may therefore extend substantially the full length of the toothbrush.

In some embodiments, the air inlet 20 may be provided on the head portion 4. In other embodiments, the air inlet 20 may be provided on the side of the handle (e.g. similar to a transverse flute).

The head 4 and/or handle 8 comprise a bio-degradable/compostable material. The head 4 and/or handle 8 may comprise an organic (i.e. non synthetic material). The toothbrush 2 is therefore environmentally friendly.

The toothbrush 2 may comprise a wood-based material. The wood-based material may comprise unaltered wood material (i.e. comprises material that is machined or cut from natural wood).

Alternatively, the wood-based material may comprise reconstituted wood material (i.e. comprises wood material that is pulverized and compacted/reformed into shape). For example, the toothbrush 2 may comprise compacted/moulded paper, cardboard or shavings. Binders or the like may be used reformation process. The binders may be biodegradable.

The toothbrush 2 may comprise bamboo wood. The toothbrush 2 may comprise raw bamboo. Alternatively, the toothbrush 2 may be made from recycled bamboo. The bamboo may be reconstituted bamboo. The bamboo may be compacted/moulded bamboo.

In some embodiments, the bristles 6 may comprise a bio-degradable/compostable material. The entire toothbrush may therefore be bio-degradable. The bristles may comprise a plant-based polymer. The bristles may comprise a plant based fibre, for example, raw plant fibres.

In alternative embodiments, the bristles 6 may comprise a recyclable material. The recyclable material may comprise a polymeric recyclable material. The bristles 6 may comprise nylon, for example, nylon 6.

The toothbrush 2 may be shaped to appeal to children and/or comprise child friendly artwork etc.

The toothbrush may further comprise one or more of: a safety razor; a makeup brush; a piece of art, jewelry or other adornments; or a string or loop to allow the user to wear the toothbrush 2 around neck or wrist.

The present invention makes toothbrushing fun and interesting for children and adults alike. The toothbrush helps to keep children engaged with a toothbrushing regime.

Detachment of the head allows the user to use the musical instrument without risk of contamination of the head. Additionally, this allows replacement of the head.

The toothbrush is biodegradable and/or recyclable, thus providing an environmentally friendly option.

1. A toothbrush (2) comprising:
a head portion (4) comprising a cleaning formation for cleaning teeth in use;
a handle portion (8) connected to the head portion (4);
characterized in that
where handle (8) and/or head portion (4) comprise a bio-degradable material;
where the toothbrush (2) comprises a musical wind instrument, the wind instrument comprising a resonant cavity (16) extending within one or both of the head portion (4) and the handle portion (8), and an air inlet (20) operatively connected to the cavity (16) and configured to induce resonance with the cavity (16) by exhalation from the user in use.

2. The toothbrush (2) according to claim 1, where the air inlet (20) is provided in an end (18) of one of the head portion (4) or the handle portion (8) and the other of the head portion (4) or handle portion (8) comprises a closed end of the resonant cavity (16).

3. (canceled)

4. (canceled)

5. The toothbrush (2) according to claim 41, where the bio-degradable material comprises a wood-based material and/or bamboo.

6. (canceled)

7. The toothbrush (2) according to claim 1, where the head portion (4) is selectively attachable to and/or detachable from the handle (8) via a screw thread (10,12).

8. (canceled)

9. The toothbrush (2) according to claim 1, where the cleaning formation comprises a plurality of bristles (6), and the bristles (6) comprise a bio degradable material and/or a plant-based fibre.

10. (canceled)

11. (canceled)

12. The toothbrush (2) according to claim 1, where the wind instrument comprises a woodwind instrument and/or a flute and/or a recorder and/or whistle.

13. (canceled)

14. (canceled)

15. The toothbrush (2) according to claim 1, where the air inlet (20) is provided at an opposing end (18) of the handle (8) to the head portion (4), and the air inlet (20) comprises a constricted portion/fipple (26).

16. (canceled)

17. The toothbrush (2) according to claim 15, where an air splitter (28) is provided downstream of the constriction (26), the air splitter (28) splitting the stream of air passing through the air inlet (20) between the cavity (16) and the ambient environment to produce a musical tone.

18. The toothbrush (2) according to claim 1, where the handle (8) and/or head portion (4) comprises one or more finger holes (36) and, the plurality of the finger holes (36) are spaced along the handle (8) in a length direction thereof.

19. (canceled)

20. The toothbrush (2) according to claim 1, where the cavity (16) extends along a majority or all of the length of the handle (8) and, the cavity (16) comprises a closed end proximal the head portion.

21. (canceled)
